(19) United States
(12) Patent Application Publication
(10) Pub. No.: US 2023/0182708 A1
(43) Pub. Date: Jun. 15, 2023

(54) Electromechanical Brake System and Method of Operation

(71) Applicant: KNORR-BREMSE Systeme fuer Nutzfahrzeuge GmbH, Muenchen (DE)

(72) Inventors: Csaba KOKREHEL, Budapest (HU); Huba NEMETH, Budapest (HU); Andreas BUCH, Taufkirchen (DE); Csaba MLINARCSEK, Budapest (HU); Wolfgang PAHLE, Bad Wiessee (DE); Michael BLESSING, Muenchen (DE); Janos SZABO, Budapest (HU)

(21) Appl. No.: 17/926,476

(22) PCT Filed: May 3, 2021
(86) PCT No.: PCT/EP2021/061504

§ 371 Date: Nov. 18, 2022

(30) Foreign Application Priority Data
May 19, 2020 (EP) 20175364.7

(51) Int. Cl. B60T 13/74; F16D 65/18; F16D 65/00

(52) U.S. Cl. CPC B60T 13/746; F16D 65/18; F16D 65/0043; F16D 2121/24

(57) ABSTRACT

An electromechanical brake system includes a brake actuator having a power transmission for transmitting an actuating force to a brake pad, the power transmission including a rotatable shaft. A coupler with a locking element can be controlled so that the locking element is engaged with the rotatable shaft and blocks its rotation or so that the locking element is disengaged from the rotatable shaft so that the rotatable shaft can be rotated. The brake actuator has an interface configured to be connected to the locking element and to engage or disengage the locking element from the rotatable shaft.

### BACKGROUND AND SUMMARY

The invention refers to an electromechanical brake system and a corresponding method of operation.

Today, electropneumatic brake actuators are frequently used in commercial vehicles. In most cases, these actuators use pneumatic energy sources via pneumatic cylinders in order to realize the actuation of both the service and the parking brake. The parking brake function is realized by an independent actuator to the service brake and can be operated independently. Due to the spring based design of the parking brake actuator, single brake actuation can also be realized without compressed air as energy source. In the event of a pressure loss in the system, the pre-tensioned spring in the parking brake chamber provides sufficient braking energy to stop the vehicle or keep it stationary. To make the vehicle towable when no compressed air supply is available on board, the parking brake actuator must be released. In combined pneumatic brake chambers, this release can be achieved by means of a threaded mechanism. A threaded shaft is led out of the brake chamber and is accessible to an operator. The brake can be released by turning this shaft with an ordinary tool.

In the future, electromechanical brake actuation will become more and more common. These brakes must also be able to be released externally. In the event of a failure, if the brakes remain applied and cannot be released in the normal course of operation, a possibility of releasing the brakes is required to make the vehicle towable. Due to the complexity of the electromechanical actuators, a new solution for an external brake release is necessary.

It is the object of the present application to provide an electromechanical brake system with brake release tools and a corresponding method permitting an external release of an electromechanical brake.

According to the invention, a parking brake mechanism of a disc brake with an external brake release function is provided. According to one aspect, the brake system comprises a brake actuator having a power transmission for transmitting an actuating force to a brake pad, said power transmission including a rotatable shaft, a coupler with a locking element, wherein the coupler can be controlled so that the locking element is engaged with the rotatable shaft and blocks its rotation or so that the locking element is disengaged from the rotatable shaft so that the rotatable shaft can be rotated, wherein the brake actuator comprises an interface configured to be connected to the locking element and to engage or disengage the locking element from the rotatable shaft.

Release of the locking element is a prerequisite before the brake can be released with a tool element, as the brake actuator and the rotatable shaft cannot be turned when they are locked by the locking element. In brake systems, the locking element is held against the rotating shaft in a parking brake condition by a spring mechanism or other means such as a permanent magnet. In addition or alternatively, a spring mechanism can be provided that pushes or pulls the locking element into the opposite direction and assists the release of the locking element with the interface.

To release the brake the tool element, which can be a wrench, is arranged in the brake actuator of the brake system so that it engages the rotatable shaft and can be used to manually move the brake actuator and release or clamp the brake once the locking element is disengaged or released from the rotatable shaft. This allows the brake system to be released and activated from the outside even when the vehicle is not in use.

The parking brake mechanism of the disc brake is particularly suitable for heavy vehicles and particularly suitable for a parking brake of an electromechanical brake (EMB) system.

According to an embodiment, the interface comprises an interface component that is configured to be pulled or pushed to disengage the locking element from the rotatable shaft. Hence, as alternatives a pull-type interface, where an interface component of the interface is configured to be pulled to disengage the locking element from the rotatable shaft, or a push-type interface can be provided, where the interface component is configured to be pushed to disengage the locking element from the rotatable shaft. The pulling or pushing can be effected by a mechanical lever or by an electric means such as an actuator or solenoid.

According to an embodiment, the interface comprises a sealed connection through which the interface component is accessible. In particular, the sealed connection can be waterproof. Furthermore, the sealed connection can be configured such that it is only accessible with a special tool.

According to another embodiment, the rotatable shaft comprises a rotating member in the form of a disk. The rotating member can be provided at one of the ends of the rotatable shaft.

According to an embodiment, the coupler comprises a spring mechanism for moving the locking element to a position in which it engages one of the sides of the rotating member. The spring mechanism can include one or more springs. In an alternative brake system, the coupler comprises other means such as a permanent magnet for holding the locking element in a position in which it engages one of the sides of the rotating member. In addition or alternatively, a spring mechanism can be provided that pushes or pulls the locking element into the opposite direction and assists the release of the locking element with the interface.

According to an embodiment, the coupler comprises a bi-stable clutch which comprises springs, a permanent magnet and a solenoid. The springs hold the locking element in one position such as the position in which the locking element engages the rotating member. The permanent magnet holds the locking element in a second position such as a position in which the locking element is disengaged from the rotating member. The solenoid is able to switch between the two positions in electrical operation. However, according to yet another embodiment, the first and the second position can be interchanged regarding the engagement or disengagement between the locking element and the rotating member, respectively.

According to yet another embodiment, the brake system comprises a receptacle into which a tool element can be inserted so that it engages with the rotatable shaft and transmits a rotation on the rotatable shaft.

According to an embodiment, the locking element has the shape of a disc and is arranged on the coupler in way so that it can be moved towards the rotating member and one of its sides is formed to engage one of the sides of the rotating member to block its rotation. The locking element also can be moved so that the one of its sides disengages from said one of the sides of the rotating member to allow its rotation.

The locking element and the rotating member of the rotatable shaft may be arranged as a releasable coupling where locking is achieved by engagement between the two opposing surfaces of the locking element and the rotating member through a mechanism which presses the locking element against the rotating member to achieve a parking brake condition. The mechanism can be a spring mechanism with one or more springs or some other means such as a permanent magnet. The mechanism may also have another arrangement in which one of the locking element or the rotating member is pulled against the respective other part to achieve the parking brake condition. The brake system may comprise means for moving the locking element with respect to the rotating member in regular brake service operation such as an electromagnetic actuator.

According to an embodiment, the locking element has a disc-shape with one or more grooves or openings permitting an engagement of an interface component to shift the locking element. The interface component can be a lever or a fork-like element.

According to an embodiment, the locking element, the rotatable shaft and the rotating member are arranged coaxially with respect to their symmetry axes.

According to an embodiment, the power transmission is electrically driven and cause a rotational movement of the rotatable shaft. An electric motor may be used as an actuator.

According to an embodiment, the coupler and the locking element are arranged in an electromagnetic parking brake locking mechanism for locking the brake actuator.

According to the invention, a method of releasing an electro-mechanical brake is also provided. The method comprises acts or steps of using an interface of a brake actuator to insert an interface component into a locking element of the brake actuator, the locking element locking movement of the brake actuator; by the interface component disengaging the locking element from a rotatable shaft of the brake actuator; and moving or turning a tool element to transmit power to the rotatable shaft to release the brake.

Alternatively or in addition, the method may comprise the steps of inserting a tool element into a brake actuator of the electro-mechanical brake so that the tool element engages a rotatable shaft of the brake actuator, and moving the tool element to transmit torque to the rotatable shaft of the brake actuator to turn the rotatable shaft and to lock the brake, controlling the interface so that the locking element engages the rotatable shaft of the brake actuator so that the locking element locks the movement of the brake actuator and the rotatable shaft in a state of a locked brake.

According to an embodiment, the method comprises the step of turning the tool element to release torque applied by the rotatable shaft to the locking element in the state of the locked brake before disengaging the locking element from the rotatable shaft.

The method can also include the action of moving the locking element into engagement with the rotatable shaft. This action can be conducted as part of the parking brake operation before use of the tool element for the disengagement of the locking element from the rotatable shaft described above but also after these actions, for example, when a vehicle has been towed and needs to be securely parked. The holding of the locking element into engagement with the rotatable shaft can be performed by a magnet, in particular, a permanent magnet of the coupler or by a spring mechanism holding the locking element into engagement with the rotatable shaft.

The method can include further steps and the features of the brake system as described above. The method can be used with an electromechanical brake with electromagnetic parking brake lock, where the electromagnetic lock such as a coupling is released first and then the brake preload is released gently using the tool element. The external operation of the brake can be carried out as a combination of one or more release steps as described above.

Further characteristics, features and advantages of the invention will result from the following description of embodiments with reference to the annexed drawing.

### BRIEF DESCRIPTION OF THE DRAWINGS

FIG. 1 is a schematic view of an electro-mechanical brake system having a pull-type release interface according to one embodiment;

FIG. 2 shows a coupling assembly of the electro-mechanical brake system according to the embodiment shown in FIG. 1;

FIG. 3 shows a schematic view of an electro-mechanical brake system having a push-type release interface according to another embodiment; and

FIG. 4 shows a coupling assembly of the electro-mechanical brake system according to the embodiment shown in FIG. 3.

### DETAILED DESCRIPTION OF THE DRAWINGS

Embodiments of the electro-mechanical brake system according to the invention are described in the following with reference to the figures.

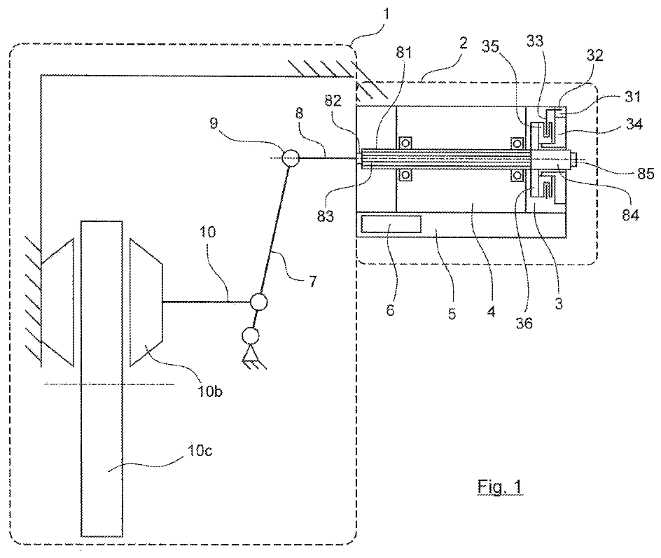

In FIG. 1, an electro-mechanical brake system is shown which comprises a brake caliper 1 and a brake actuator 2 which is connected to the brake caliper 1 and comprises a force transmission mechanism including a shaft assembly 8 and a lever assembly connected to the shaft assembly 8 via a push type or push-pull type joint 9. The lever assembly transmits the actuation force from a motor 4 such as an electric motor to one or more brake pads 10b via a push mechanism 10 which is in connection with a lever 7 of the lever assembly. The brake actuator 2 is constructed so that an actuation force generated by the motor 4 that is connected with a rotatable shaft 81 is transferred by a translational element 82 of the shaft assembly 8 via a rotational-translational converter mechanism as a translational force to the lever 7 which by rotation about a fixed point at the end of the lever 7 transfers the force to the one or more brake pads 10b that can contact a brake disc 10c in a braking operation. The brake actuator 2 also comprises an electromagnetic coupling or clutch assembly 3.

The rotatable shaft 81 of the shaft assembly 8 extends throughout the entire brake actuator 2 and projects to the outside of the actuator housing through an electromagnetic clutch unit 3. The rotatable shaft 81 of shaft assembly 8 may be designed as a single part 81 or as two separate parts 81, 84, in which case the second part 84 is rotationally fixed to the first part 81. In this case, the second part 84 of the rotatable shaft 81 of the shaft assembly 8 can be an integral part of the clutch assembly 3.

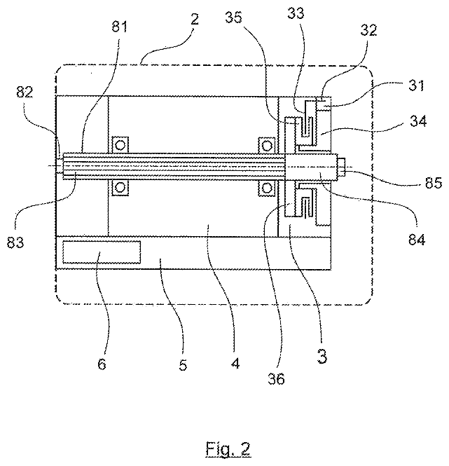

The clutch assembly 3, which is shown in FIG. 2 in greater detail, has a rotating member 36 which is connected to the rotatable shaft 81 of the shaft assembly 8. The coupling assembly 3 further comprises a coupling body 34 with an electromagnetic actuator inside and a locking element 35 that can be shifted by the electromagnetic actuator. The clutch assembly 3 comprises a bi-stable clutch which comprises one or more springs, a permanent magnet and a solenoid (not shown). The springs hold the locking element 35 in a first position such as the position in which the locking element 35 engages the rotating member 36 of the rotatable shaft 81. The permanent magnet holds the locking element 35 in a second position such as a position in which the locking element 35 is disengaged from the rotating member 36. The coupling body 34 which comprises a solenoid is able to switch between the two positions in electrical operation. This represents just one example of a clutch assembly. Another coupling mechanism could be used instead. In particular, a clutch assembly can be provided in which the functions of the one or more springs and of the permanent magnet are interchanged so that the permanent magnet holds the locking element 35 in the first position in which the locking element 35 engages the rotating member 36 and the one or more springs hold the locking element 35 in the second position in which the locking element 35 is disengaged from the rotating member 36.

In a locked position, the coupling body 34 forces the locking element 35 in contact with the rotating member 36 of the rotatable shaft 81. In the contact position, the rotating member 36 and the locking element 35 and also the rotating member 36 and the coupling body 34 are torque-proof. In this way the coupling assembly 3 can fix the rotatable shaft 81 in a position which provides a constant brake force if the locking element 35 is activated after the clamping force has been applied by the brake actuator 2 to the one or more brake pads 10b.

For an external release of the parking brake, an interface 31 is provided at the end of the actuator housing. This interface 31 is sealed and preferably waterproof and comprises an interface component 32 such as a release element 33 that is only accessible with special tools. FIG. 2 shows a pull-type release interface 31, where the interface component is configured or arranged to be pulled to disengage locking element 35 from the rotating member 36 with the help of a fork-like release element 33 which is in contact with the locking element 35. The fork-like release element 33 engages into grooves or openings in the locking element 35 and can be pulled mechanically or magnetically by means of an actuator.

For a smooth release of the brake, the rotatable shaft 81 can be held with help of a wrench (not shown) which engages the rotatable shaft 81 or the rotating member 36 which is connected to it. After the locking element 35 is disengaged from the rotatable shaft 81 the pre-tensioned brake can be released by rotating the rotatable shaft 81 with the wrench.

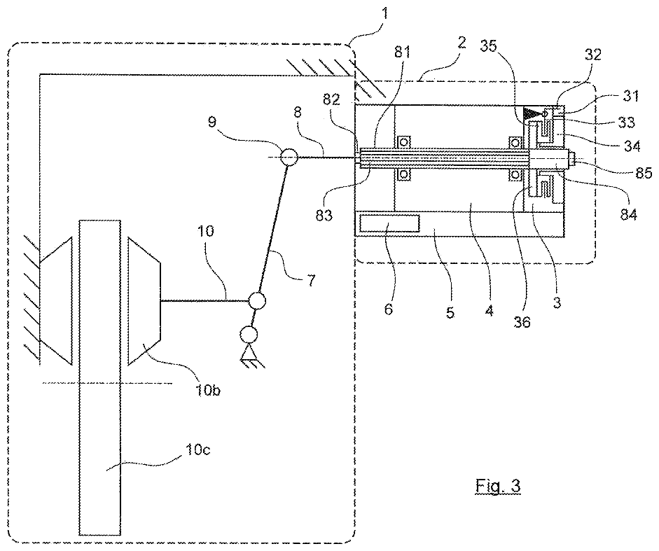

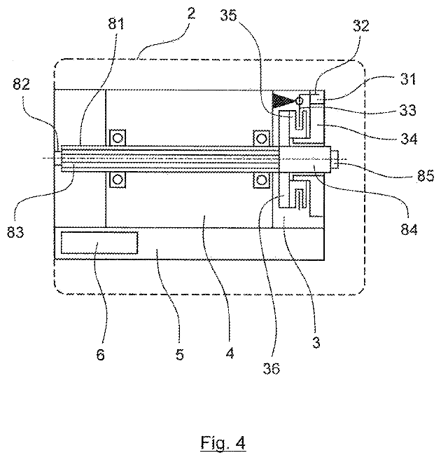

In the embodiment shown in FIG. 3, a push-type release interface 31 is provided, where the interface component 32 is configured to be pushed to disengage the locking element 35 of the clutch assembly 3 from the rotational element 36 with the help of a lever-like release element 33 which is in contact with locking element 35. FIG. 4 shows the clutch assembly 3 with the push-type release interface 31 in greater detail. Besides the push-type release interface 31, the electro-mechanical brake shown in FIGS. 3 and 4 corresponds to the electro-mechanical brake shown in FIGS. 1 and 2. The same or corresponding reference numerals are used throughout the figures.

Various modifications can be provided in the embodiments shown in the figures without leaving the scope of the invention.

### REFERENCE NUMERALS

1 brake caliper
2 brake actuator
3 electromagnetic coupling assembly
4 electric motor
7 lever assembly
8 shaft assembly
9 joint
10 push mechanism
10b brake pad
10c brake disc
31 interface
32 interface component
33 release element
34 coupling body
35 coupling moving element
36 rotating member
81 rotatable shaft
82 translational element

1.-12. (canceled)

13. An electromechanical brake system, comprising:
a brake actuator having a power transmission for transmitting an actuating force to a brake pad, said power transmission including a rotatable shaft;
a coupler with a locking element, wherein the coupler is controllable so that the locking element is engaged with the rotatable shaft and blocks rotation of the rotatable shaft or so that the locking element is disengaged from the rotatable shaft so that the rotatable shaft is rotatable, wherein
the brake actuator comprises an interface configured to be connected to the locking element and to engage or disengage the locking element from the rotatable shaft.

14. The brake system according to claim 13, wherein
the interface comprises an interface component that is configured to be pulled or pushed to disengage the locking element from the rotatable shaft.

15. The brake system according to claim 14, wherein
the interface comprises a sealed connection through which the interface component is accessible.

16. The brake system according to claim 13, wherein
the rotatable shaft comprises a rotating member in the form of a disk.

17. The brake system according to claim 16, wherein
the coupler comprises a spring for moving the locking element to a position in which the locking element engages one side of the rotating member.

18. The brake system according to claim 13, further comprising:
a first receptacle into which a tool element is insertable so that the tool member engages the rotatable shaft and transmits a rotation on the rotatable shaft.

19. The brake system according to claim 16, wherein
the locking element has a disc shape and is arranged on the coupler so that the locking element is movable so that one side of the locking element is engageable with one side of the rotating member to block rotation of the rotating member and is disengagable from said one side of the rotating member to allow rotation of the rotating member.

20. The brake system according to claim 13, wherein
the locking element has a disc-shape with one or more grooves or openings permitting engagement of an interface component.

21. The brake system according to claim 13, wherein
the power transmission is electrically driven and causes a rotational movement of the rotatable shaft.

22. The brake system according to claim 13, wherein
the coupler is arranged in an electromagnetic parking brake locking mechanism for locking the brake actuator.

23. A method of releasing an electro-mechanical brake, comprising:
using an interface of a brake actuator to insert an interface component into a locking element of the brake actuator, the locking element locking movement of the brake actuator;
disengaging, by way of the interface component, the locking element from a rotatable shaft of the brake actuator; and
moving a tool element to transmit power to the rotatable shaft to release the brake.

24. The method according to claim 23, further comprising:
turning the tool element to release torque applied by the rotatable shaft to the locking element in the state of the locked brake before disengaging the locking element from the rotatable shaft.
